(19) United States
(12) Patent Application Publication
(10) Pub. No.: US 2021/0062502 A1
(43) Pub. Date: Mar. 4, 2021

(54) AN IMPROVED FIRE-STOP INSERT

(71) Applicant: Rectorseal, LLC, Houston, TX (US)

(72) Inventors: Riley Archer, The Woodlands, TX (US); Harvey Steven Grodjesk, Houston, TX (US); Gary Clark, The Woodlands, TX (US); Robert Martinelli, Katy, TX (US)

(21) Appl. No.: 16/643,902

(22) PCT Filed: Sep. 25, 2018
(86) PCT No.: PCT/US2018/052618

§ 371 Date: Mar. 3, 2020

Related U.S. Application Data
(60) Provisional application No. 62/708,052, filed on Nov. 30, 2017.

(51) Int. Cl. E04B 1/94; A62C 2/06

(52) U.S. Cl. CPC E04B 1/944; A62C 2/06

(57) ABSTRACT

An improved fire-retarded insert for forming a fire and thermal barrier between the bottom of a fluted deck structure and the top-of-walls is disclosed. The fire-retardant insert comprises an elongated fire-retardant member and at least one intumescent member in contact with the top, bottom, side, or end surfaces of the fire-retardant member, or positioned within the interior of the fire-retardant member. The fire-retardant member and the intumescent member are circumscribed preferably by a thin flexible film, such as shrink-wrap, to fully encase the fire-retardant insert making the installation easier and safer.

### CROSS REFERENCE TO RELATED APPLICATION

This application claims priority to International Application PCT/US2018/052618 which claims priority to U.S. Provisional Patent Application Ser. No. 62/708,052, filed Nov. 30, 2017, and entitled “Fluted Deck Fire-Stop Plug”, of which the entire content of International Application PCT/US2018/052618 and U.S. Provisional Patent Application Ser. No. 62/708,052 are hereby incorporated by reference and made a part hereof.

### FIELD OF THE INVENTION

The present invention relates generally to an improved insert to create a fire-stop plug and thermal barrier. More particularly, the present invention relates to an improved fire-stop insert and thermal barrier for building joint structures used in openings or gaps formed between a top of a wall and ceilings or floors having fluted decks.

### BACKGROUND OF THE INVENTION

Fire-stops are thermal barrier materials or combinations of materials used for filling gaps and openings such as in the joints between fire-rated walls and/or floors of buildings. For example, fire-stops inserts or plugs can be used in walls or floors to prevent fire and smoke from passing through the gaps or openings required for cables, pipes, ducts, or other conduits. Fire-stops inserts are also used to fill joint gaps that occur between walls, between a ceiling and the top of a wall (“head-of-wall”). The gaps in a “head of wall” joint can be particularly difficult to fill with fire-stopping material ceilings (or floors) because the decks (i.e. ceilings or floors) are increasingly being made by pouring concrete onto fluted steel deck. The fluted steel deck leaves a relatively large gap between the top of the wallboard (often gypsum) and the upper end of the opening caused by the shape of the fluted deck.

For such head-of-wall joints, mineral wool batt may be used as a thermal resistant fire-stop material due to its ability to accommodate cyclic movements of the wallboard material. In such instances sheets of the batting may need to be stacked and compressed when inserted into the joint gap. In some situations, a fire-proofing material is spray-applied into the spaces of the fluted ceiling to supplement the mineral wool in the joint. In either case, the mineral wool approach requires labor and time. Additionally, mineral wool is an irritant, which requires specialized protective gear to protect the installer.

Thus, the need exists for an improved fire-stop insert which is easier to install but can also fill additional gaps if a fire occurs to seal off rooms.

The need also exists to accomplish the primary objective noted above in a more efficient, convenient and cost-effective installation manner. Historical construction methods required a worker to climb up and down ladders in protective gear on a frequent basis when working on head-of-wall joint assemblies. The more frequent these trips on a ladder the more inherently dangerous is the installation process. In view of the prior art disadvantages, novel thermal barriers and methods are needed.

### SUMMARY OF THE INVENTION

In order to overcome the disadvantages of the prior art, the present invention provides a method and system for installing a thermal barrier in openings and gaps in or between building structures such as walls, ceilings and floors. In so doing, the present invention provides increased convenience, effectiveness and safety in comparison to the prior art mineral wool/coating and other methods. Additionally, mineral wool is an irritant, the shrink wrap or other coating protects the installer from coming in direct contact with the mineral wool.

The present invention comprises an elongated fire retardant member. The fire-retardant member includes a top surface, a bottom surface, end surfaces and side surfaces. Each side surface and end surface contacts either the top surface of the bottom surface. The top and bottom surfaces are substantially parallel while the side services are nonparallel so that the cross-sectional shape of the fire-retarded member is trapezoidal. The present invention also includes at least one intumescent member which extends along at least a portion of the longitudinal axis of the fire-retardant member. The intumescent member contacts one or more of each surface of the trapezoidal member—top, bottom, sides, or ends. Alternatively, the intumescent member may be positioned within the fire retardant member between the top and bottom surfaces. The present invention also includes a means for affixing the intumescent member to one or more surfaces of, or within, the fire retardant member.

Preferably, the fire-retardant member is made of mineral wool or other suitable material.

The affixing means is preferably a flexible film which circumscribes the fire retardant member and all the intumescent members. Preferably, it circumscribes the end portions of the fire-retardant member as well. Alternatively, the intumescent members may be attached with an adhesive or adhesive tape.

In at least one embodiment of the present invention, the at least one intumescent member contacts the top surface of the fire retardant-member.

In another embodiments of the present invention, the at least one intumescent member contacts any surface of the fire-retardant member, including the bottom, side, or edge surfaces.

In yet another embodiment of the present invention, intumescent members contacts two or more surfaces of the fire-retardant member, including the top, bottom, side and edges surfaces.

In yet a further embodiment of the present invention, the at least one intumescent member is embedded within the fire-retardant member.

Preferably, the fire-retardant member is made of mineral wool or other suitable material.

Other and further objects, features, and advantages of the present invention will be apparent from the following description of the present invention, given for the purpose of disclosure, and taken in conjunction with the accompanying drawings.

### BRIEF DESCRIPTION OF THE DRAWINGS

FIG. 1 is an elevation view of a fluted deck and the prior art.

FIG. 2A is an isometric of one embodiment of the present invention.

FIG. 2B is a cross-sectional view taken along line 2B-2B of FIG. 2A.

FIG. 3A is another isometric of the one embodiment of the present invention.

FIG. 3B is a cross-sectional view taken along line 3B-3B of FIG. 3A.

FIG. 4A is an isometric of another embodiment of the present invention.

FIG. 4B is a cross-sectional view taken along line 4B-4B of FIG. 4A.

FIG. 5A is an isometric view of yet another embodiment of the present invention.

FIG. 5B is a cross-sectional view taken along line 5B-5B of FIG. 5A.

FIG. 6A is an isometric view of yet again another embodiment of the present invention.

FIG. 6B is a cross-sectional view taken along line 6B-6B of FIG. 6A.

FIG. 7A is an isometric view of yet a further embodiment of the present invention.

FIG. 7B is a cross-sectional view taken along line 7B-7B of FIG. 7A.

FIG. 8A is an isometric view of yet again a further alternate embodiment of the present invention.

FIG. 8B is a cross-sectional view taken along line 8B-8B of FIG. 8A.

FIG. 9A is an isometric view of a further alternate embodiment of the present invention.

FIG. 9B is a cross-sectional view taken along line 9B-9B of FIG. 9A.

FIG. 10A is an isometric view of yet a further alternate embodiment of the present invention.

FIG. 10B is a cross-sectional view taken along line 10B-10B of FIG. 10A.

FIG. 11 is an elevation view of a fluted deck and the present invention.

### DETAILED DESCRIPTION OF THE PREFERRED EMBODIMENTS

Referring now to FIG. 1, a fluted top deck 100 is shown spanning between joists (not shown) in a building. Concrete 110 is typically poured onto fluted top deck 100 to form the flooring of the next story or to form the top ceiling for the building. By using fluted deck 100 a trapezoidal gap 120 is formed. In order to create a fire and thermal barrier within gap 120 between rooms 130/132 a fire-stop plug 140 is frequently installed in gap 120. Walls 150/152 are typically built up to fluted top deck 100 and walls 150/152 are capped with a prefabricated header 155. Dry wall or other suitable sheeted material 156 is installed on either side of walls 150/152. Such construction techniques are well known to those skilled in the art.

Referring still to FIG. 1, once walls 150/152 are installed but before sheeted material 156 is installed, trapezoidal gap 120 is filled with prior art fire barrier materials 140. For example, prior art plugs 140 made of pre-shaped trapezoidal blocks are available under the trade name Delta Deck Plugs from Rock Wool Manufacturing Company of Leeds, Alabama. Typically, prior art plugs 140 are made of mineral wool. When installed in gap 120, such prior art plugs provide fire and thermal barrier, and also provide a smoke and acoustic barrier. The Delta Deck Plugs are precision-cut from noncombustible UL classified high-density mineral fiber to satisfy the UL Fire Resistance Directory, 2007 edition. Such prior art plugs 140 are available currently in three standard sizes to closely match the profiles for gaps 120 of the most frequently specified fluted metal decks 100. However, even with the insertion of a prior art plug 140 spaces may remain within the gaps 120, particularly if telephone, Internet, and other cables have been run within gaps 120 before the installation of prior art plugs 140. Thus, the need remains for an improved plug to fill gap 120 in the event of a fire particularly to seal around smaller air gaps resulting from the telephone and other cables run within the gaps 120 previously. As used herein, the terms “insert” or “plug” are used synonymous.

Another problem with prior art plugs 140 stems from their material of manufacture. Mineral wool, and similar products used, are friable (e.g., they easily crumble). This makes the handling of the product difficult. Furthermore, there is a safety issue. Mineral wool can cause respiratory problems. Hence, the handling of the material must be done carefully and with adequate protective gear for the worker. This situation is aggravated if multiple trips up/down a ladder are required and the same piece of mineral wool is handled multiple times.

Therefore, the need exists for an improved fire and smoke barrier that conforms more completely to gap 130 particularly if smaller air gaps also exist due to the prior installation of cables. An improved fire-retardant insert should also address the safety and repeated handling of the product by the workers during installation.

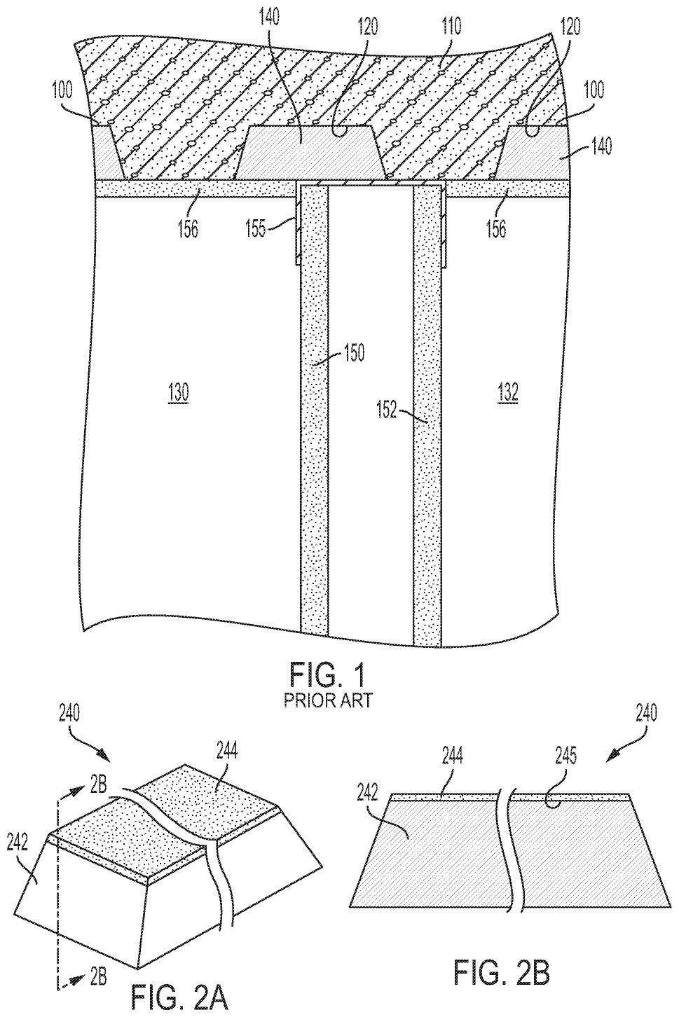

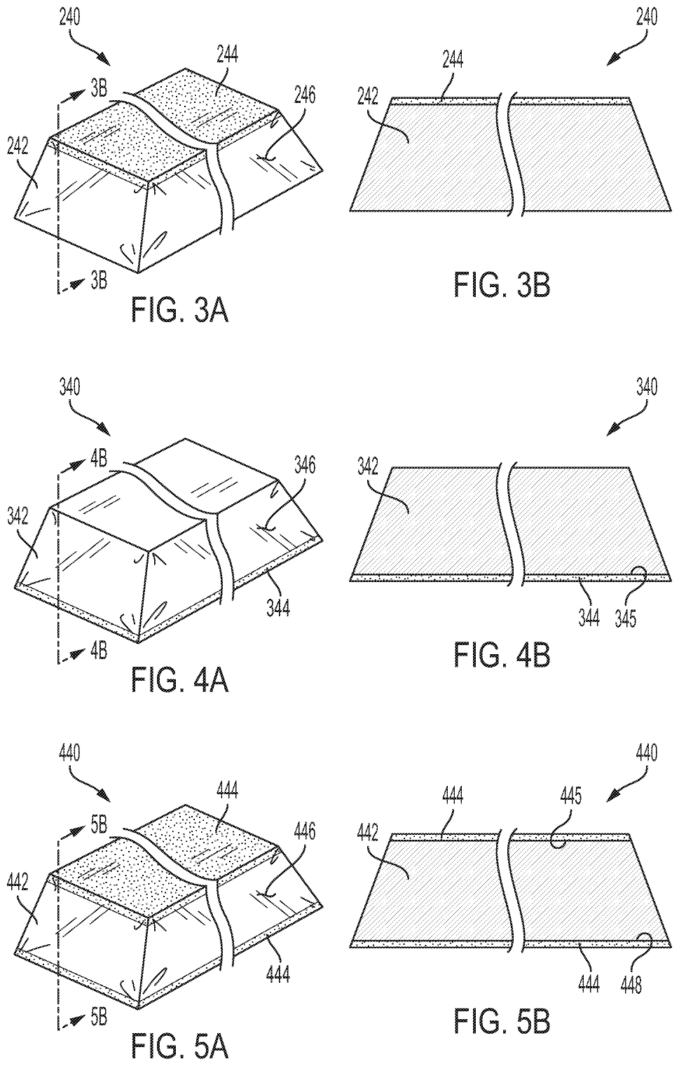

Referring now the FIGS. 2A/B-3A/B, the present invention comprises an improved fire-stop insert 240 including an elongated fire-retardant member 242. Preferably, fire-retardant member 242 is made of mineral wool and having the dimensions such as that known as Delta Deck Plugs from Rock Wool Manufacturing Company, as noted above. The present invention also includes an elongated intumescent member 244 (a/k/a intumescent strip) in contact with the top surface 245 of member 242. Intumescent members or strips are known for their expansive qualities when exposed to heat and are usually rated to last either 30 mins or 60 mins. Such an intumescent strips are commercially available from the Rectorseal Company of Houston, Tex., www.rectorseal.com, under the brand BLAZE SEAL™. Typically, intumescent member 244 will expand to many times its original normal size when exposed to heat or fire. Intumescent member 244 is typically from about 1.5 mm to 5 mm thick and can be cut into various sizes and shapes to match the particular surfaces of fire-retardant member 242.

As shown in FIGS. 2A/B and 3A/B, it is necessary to attach or affix intumescent member 244 to fire-retardant member 242. Such may be accomplished by an adhesive or an adhesive tape, for example. If member 242 is made of mineral wool or other friable material it can be difficult to attach a product such as intumescent member 244 to mineral wool using adhesives or an adhesive tape because friable mineral wool easily crumbles. Accordingly, in at least one embodiment of the disclosure herein, intumescent members 244 is held in contact with member 242 using a thin flexible film 346, such as shrink-wrap. The intumescent member 242 is help atop surface 245 in the embodiment of FIGS. 2A/B and 3A/B and then wrapped with thin flexible film 246.

Film 246 may be adhered to retain member 242 and 244 at a sufficiently low enough temperature without affecting the expansive properties of intumescent member 244. Such is occasionally referred to as shrink-wrap film. Shrink-wrap file is typically a polymer plastic films (e.g polyolefins) that is shrunk tightly over the workpiece when heat is applied to them. The heat can be applied in various ways (e.g. conveyors, head guns or heat tunnels).

Alternatively, film 246 may be installed using a stretch wrapping process. That is, a flexible plastic film is physically stretched over insert 240 rather than using heat to shrink the film.

Shrink-wrapping or stretch-wrapping film 246 should be tight enough to hold the intumescent member 244 to fire-retardant member 242 but not be so tight that it deforms the shape of member 242 or causes it to crumble. This compression method of attachment obviates the problems with mineral wool being friable (for example, adhesives or tapes simply pulling off the surfaces of a mineral wool member 242).

Shrink-wrapping or stretch-wrapping film 246 also has the added safety and health benefit of enclosing or circumscribing members 242 and 244 so that workers do not have contact with these materials during installation. Additionally, wrapping members 242 and 244 with a thin film helps strengthen insert 240, thereby maintaining its integrity a particular piece of insert 240 if it needs to be handled multiple times during installation.

Referring now to FIGS. 4A/B, an alternate embodiment of the present invention is shown comprising an improved fire-stop insert 340 including an elongated fire-retardant member 342 and an intumescent member 344 in contact with the bottom surface 345 of fire-retardant member 342. Again, fire-retardant member 342 is preferably made of mineral wool as discussed above in the embodiment shown in FIGS. 2A/B and 3A/B. Furthermore, as also discussed above with respect to FIGS. 2A/B and 3A/B, intumescent member 344 in contact with a surface of fire-retardant member 342 may attached to member 342 by an adhesive or an adhesive tape. Alternatively, intumescent member 344 may be retained in position in contact with member 342 by film 346 using shrink-wrapping or stretch wrapping techniques as discussed above with respect to FIGS. 2A/B and 3A/B. All such prior disclosures for FIGS. 2A/B and 3A/B relating to fire-stop insert 240, fire-retardant member 242, intumescent member 244, and film 246, and the properties and techniques for fabrication and installation of same apply to the embodiment shown in FIGS. 4A/B and are hereby incorporated by reference.

Referring now to FIGS. 5A/B, yet another embodiment of the present invention is shown comprising an improved fire-stop insert 440 including an elongated fire-retardant member 442 and intumescent members 444 in contact with the top surface 445 and the bottom surfaces 448 of fire-retardant member 442. Again, fire-retardant member 442 is preferably made of mineral wool as discussed above in the embodiment shown in FIGS. 2A/B and 3A/B. Furthermore, as also discussed above with respect to FIGS. 2A/B and 3A/B, intumescent members 444 in contact with the two surfaces 445/448 of fire-retardant member 442 may attached to member 442 by an adhesive or an adhesive tape. Alternatively, intumescent members 444 may be retained in position in contact with member 442 by film 446 using shrink-wrapping or stretch wrapping techniques as discussed above with respect to FIGS. 2A/B and 3A/B. All such prior disclosures for FIGS. 2A/B and 3A/B relating to fire-stop insert 240, fire-retardant member 242, intumescent member 244, and film 246, and the properties and techniques for fabrication and installation of same apply to the embodiment shown in FIGS. 5A/B and are hereby incorporated by reference.

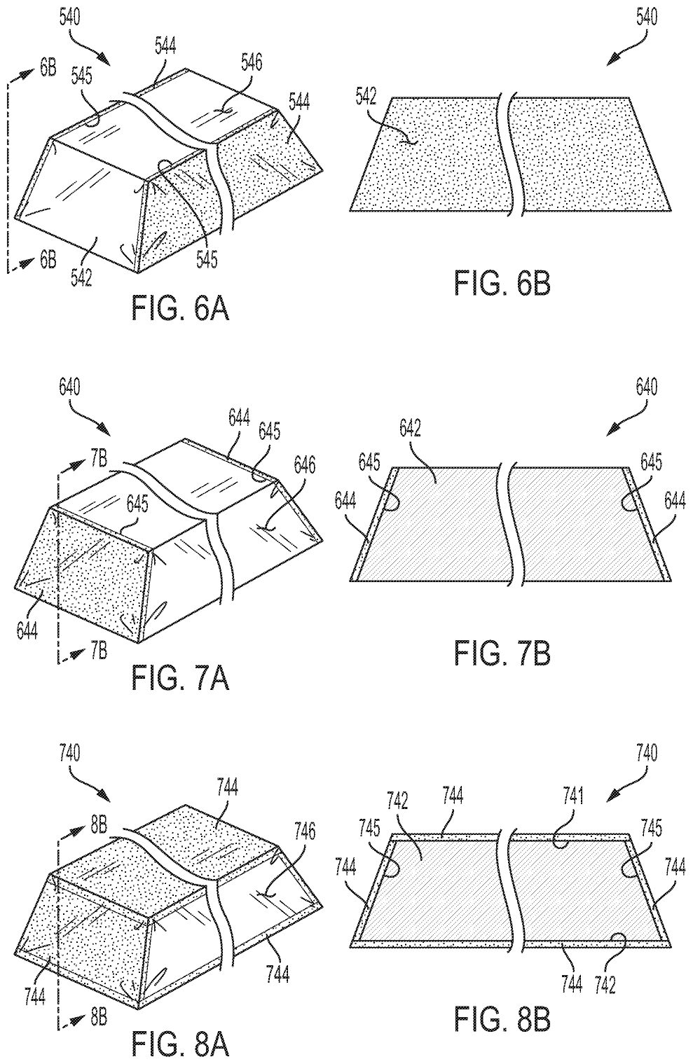

Referring now to FIGS. 6A/B, yet again another embodiment of the present invention is shown comprising an improved fire-stop insert 540 including an elongated fire-retardant member 542 and intumescent members 544 in contact with the side surfaces 545 of fire-retardant member 542. Again, fire-retardant member 542 is preferably made of mineral wool as discussed above in the embodiment shown in FIGS. 2A/B and 3A/B. Furthermore, as also discussed above with respect to FIGS. 2A/B and 3A/B, intumescent members 544 in contact with the two surfaces 545 of fire-retardant member 542 may attached to member 542 by an adhesive or an adhesive tape. Alternatively, intumescent members 544 may be retained in position in contact with member 542 by film 546 using shrink-wrapping or stretch wrapping techniques as discussed above with respect to FIGS. 2A/B and 3A/B. All such prior disclosures for FIGS. 2A/B and 3A/B relating to fire-stop insert 240, fire-retardant member 242, intumescent member 244, and film 246, and the properties and techniques for fabrication and installation of same apply to the embodiment shown in FIGS. 6A/B and are hereby incorporated by reference.

Referring now to FIGS. 7A/B, yet a further embodiment of the present invention is shown comprising an improved fire-stop insert 640 including an elongated fire-retardant member 642 and intumescent members 644 in contact with the end surfaces 645 of fire-retardant member 642. Again, fire-retardant member 642 is preferably made of mineral wool as discussed above in the embodiment shown in FIGS. 2A/B and 3A/B. Furthermore, as also discussed above with respect to FIGS. 2A/B and 3A/B, intumescent members 644 in contact with the two surfaces 645 of fire-retardant member 642 may attached to member 642 by an adhesive or an adhesive tape. Alternatively, intumescent members 644 may be retained in position in contact with member 642 by film 646 using shrink-wrapping or stretch wrapping techniques as discussed above with respect to FIGS. 2A/B and 3A/B. All such prior disclosures for FIGS. 2A/B and 3A/B relating to fire-stop insert 240, fire-retardant member 242, intumescent member 244, and film 246, and the properties and techniques for fabrication and installation of same apply to the embodiment shown in FIGS. 7A/B and are hereby incorporated by reference.

Referring now to FIGS. 8A/B, yet again a further embodiment of the present invention is shown comprising an improved fire-stop insert 740 including an elongated fire-retardant member 742 and intumescent members 744 in contact with the top surface 741, bottom surface 742 and end surfaces 745 of fire-retardant member 742. Again, fire-retardant member 742 is preferably made of mineral wool as discussed above in the embodiment shown in FIGS. 2A/B and 3A/B. Furthermore, as also discussed above with respect to FIGS. 2A/B and 3A/B, intumescent members 744 in contact with the top, bottom and end surfaces 741/742/745 of fire-retardant member 742 may attached to member 742 by an adhesive or an adhesive tape. Alternatively, intumescent members 744 may be retained in position in contact with member 742 by film 746 using shrink-wrapping or stretch wrapping techniques as discussed above with respect to FIGS. 2A/B and 3A/B. All such prior disclosures for FIGS. 2A/B and 3A/B relating to fire-stop insert 240, fire-retardant member 242, intumescent member 244, and film 246, and the properties and techniques for fabrication and installation of same apply to the embodiment shown in FIGS. 8A/B and are hereby incorporated by reference.

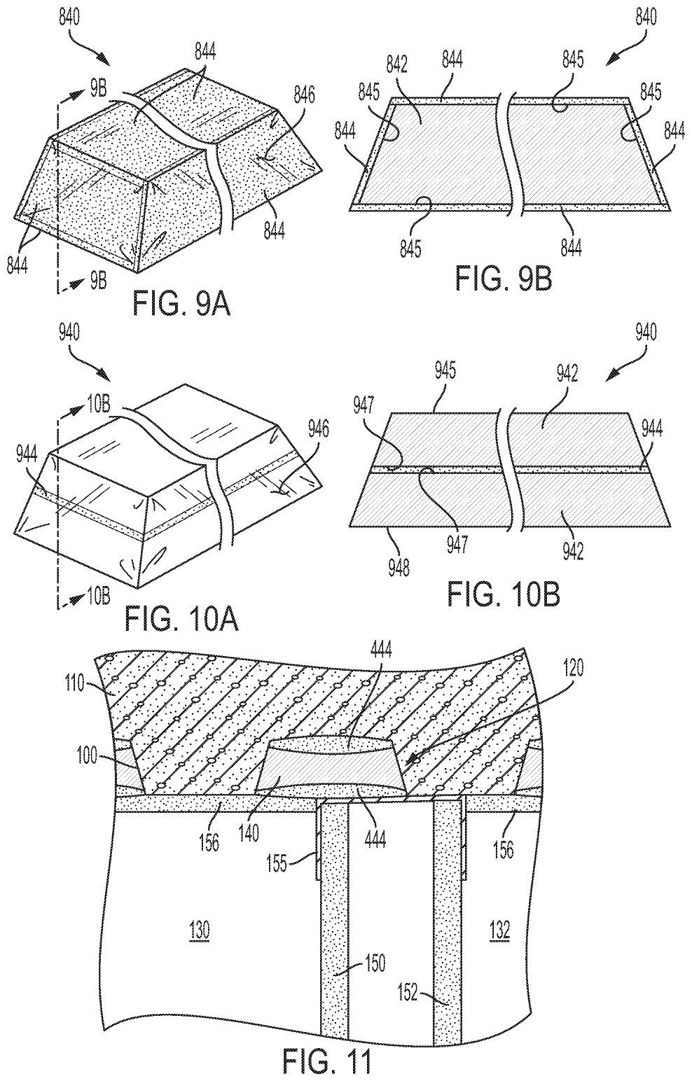

Referring now to FIGS. 9A/B, a further alternate embodiment of the present invention is shown showing the combination resulting from FIGS. 6A/B and 8A/B. That is, the present invention comprises an improved fire-stop insert 840 including an elongated fire-retardant member 842 and intumescent members 844 in contact with all six surfaces 845 (top/bottom/sides(2)/ends(2)) of fire-retardant member 842. Again, fire-retardant member 842 is preferably made of mineral wool as discussed above in the embodiment shown in FIGS. 2A/B and 3A/B. Furthermore, as also discussed above with respect to FIGS. 2A/B and 3A/B, intumescent members 844 in contact with all surfaces 845 of fire-retardant member 842 may attached to member 842 by an adhesive or an adhesive tape. Alternatively, intumescent members 844 may be retained in position in contact with member 842 by film 846 using shrink-wrapping or stretch wrapping techniques as discussed above with respect to FIGS. 2A/B and 3A/B. All such prior disclosures for FIGS. 2A/B and 3A/B relating to fire-stop insert 240, fire-retardant member 242, intumescent member 244, and film 246, and the properties and techniques for fabrication and installation of same apply to the embodiment shown in FIGS. 9A/B and are hereby incorporated by reference.

Referring now to FIGS. 10A/B, yet a further alternate embodiment of the present invention comprising an improved fire-stop insert 940 including an elongated fire-retardant member 942 and intumescent member 944 embedded or sandwiched within fire-resistant member 942. This configuration can be manufactured by cutting member 942 into two sections along a cut line substantially parallel with top and bottom surfaces 945/948. Again, fire-retardant member 942 is preferably made of mineral wool as discussed above in the embodiment shown in FIGS. 2A/B and 3A/B. Furthermore, as also discussed above with respect to FIGS. 2A/B and 3A/B, intumescent member 944 in contact with interior surfaces 947 of fire-retardant member 942 may attached to member 942 by an adhesive or an adhesive tape. Alternatively, intumescent member 944 may be retained in position in contact with member 942 by film 946 using shrink-wrapping or stretch wrapping techniques as discussed above with respect to FIGS. 2A/B and 3A/B. All such prior disclosures for FIGS. 2A/B and 3A/B relating to fire-stop insert 240, fire-retardant member 242, intumescent member 244, and film 246, and the properties and techniques for fabrication and installation of same apply to the embodiment shown in FIGS. 10A/B and are hereby incorporated by reference.

Referring now to FIG. 11, the performance of the present invention is shown following wherein the embodiment shown in FIGS. 5A/B has been subjected to a fire incident. As previously noted above, fluted top deck 100 is shown spanning between joists (not shown) in a building. Concrete 110 is poured onto fluted top deck 100 to form the flooring of the next story or to form the top ceiling for the building. Fluted deck 100 forms trapezoidal gaps 120. Fire-stop insert 440 is shown within gap 120 having in tumescent members 444. As a result of a fire intumescent members 444 are shown in an expanded state compressing against all surfaces contacting intumescent members 444. This results in the compression and deformation of member 442 thereby fully sealing gap 120 and any other air gaps within gap 120 that might exist as a result of cables or other mechanical building components elements within gap 120 (not shown). Such a sealing results in depriving any fire of air and the ability to migrate from room 130 to room 132.

In view of the various embodiments shown in FIGS. 2A/B to 10A/B, the present invention provides flexibility. As such, the present invention is capable of passing fire endurance tests and hose stream tests in accordance with UL Standard for Safety for Tests for Fire Resistance of Building Joint Systems, UL 2079.

To further enhance the performance of the present invention, other known “head of wall” fire-stop devices may be used in combination with the present invention such as the Blaze Foam® backer rod product from the RectorSeal Company or the Hot Rod® backer rod from the CEMCO Steel Company.

Having thus described in detail a preferred selection of embodiments of the present invention, it is to be appreciated and will be apparent to those skilled in the art that many physical changes could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein

This written description provides specific details and processing conditions in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional techniques employed in the industry.

Furthermore, characteristics and advantages of the present disclosure and additional features and benefits will be readily apparent to those skilled in the art upon consideration of the detailed description of exemplary embodiments of the present disclosure and referring to the accompanying figures. It should be understood that the description herein and appended drawings, being of exemplary embodiments, is not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

As used herein, the terms “disclosure”, “present disclosure,” “present invention” and variations thereof are not intended to mean every possible embodiment encompassed by this disclosure or any particular claim(s).

Certain terms are used herein and in the appended claims to refer to particular components. As one skilled in the art will appreciate, different persons may refer to a component by different names. This disclosure does not intend to distinguish between components that differ in name but not function. Also, the terms “including,” “having,” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

All ranges disclosed herein are inclusive of the endpoints, and the endpoints are independently combinable with each other.

The suffix “(s)” as used herein is intended to include both the singular and the plural of the term that it modifies, thereby including at least one of that term.

The use of the terms “a,” “an,” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another.

What is claimed is:

1. A fire-retardant insert comprising:
an elongated fire-retardant member having a longitudinal axis and comprising a top surface, a bottom surface, end surfaces and side surfaces, the edges of each end surface and side surface contacting said top surface or said bottom surface, said top and bottom surfaces being substantially parallel and said side surfaces being non-parallel, so that said fire-retardant member is trapezoidal in cross-section;
at least one intumescent member extending along at least a portion of the longitudinal axis of said fire-retardant member and contacting at least one of said surfaces of said fire-retardant member or positioned within said fire-retardant member between said top and bottom surfaces; and
means for holding said intumescent member in contact with at least one of said surfaces of said fire-retardant member or within said fire-retardant member between said top and bottom surfaces.

2. The fire-retardant insert according to claim 1 wherein said fire-retardant member comprises mineral wool.

3. The fire-retardant insert according to claim 1 further comprising a second intumescent member extending along at least a portion of the longitudinal axis of said fire-retardant member and contacting another of said surfaces of said fire-retardant member, said second intumescent member being substantially parallel to said at least one intumescent member.

4. The fire-retardant insert according to claim 1 wherein said means for affixing comprises an adhesive.

5. The fire-retardant insert according to claim 1 wherein said means for affixing comprises a flexible film circumscribing the top, bottom, and side surfaces of said fire-retardant member and said at least one intumescent member.

6. The fire-retardant insert according to claim 2 wherein said film further circumscribes the end surfaces of said fire-retardant member.

7. The fire-retardant insert of according to claim 5 wherein said means for affixing comprises a flexible film circumscribing the top, bottom, and side surfaces of said fire-retardant member and all intumescent members.

8. The fire-retardant insert according to claim 1 wherein said intumescent member contacts the top surface of said fire-retardant member.

9. The fire-retardant insert according to claim 8 wherein said intumescent member contacts the bottom surface of said fire-retardant member.

10. The fire-retardant insert according to claim 9 wherein said intumescent member contacts the end surfaces of said fire-retardant member.

11. The fire-retardant insert according to claim 1 wherein said intumescent member contacts the top surface and the bottom surface of said fire-retardant member.

12. The fire-retardant insert according to claim 1 wherein said intumescent member contacts the side surfaces

13. The fire-retardant insert according to claim 1 wherein said intumescent member is positioned within the fire-retardant member.

14. A fire-retardant insert comprising:
an elongated fire-retardant member having a longitudinal axis and comprising a top surface, a bottom surface, end surfaces and side surfaces, the edges of each end surface and side surface contacting said top surface or said bottom surface, said top and bottom surfaces being substantially parallel and said side surfaces being non-parallel, so that said fire-retardant member is trapezoidal in cross-section;
at least one intumescent member extending along at least a portion of the longitudinal axis of said fire-retardant member and contacting top surface of said fire-retardant member; and
means for holding said intumescent member in contact with said top surface.

15. The fire-retardant insert according to claim 14 further comprising a second intumescent member extending along at least a portion of the longitudinal axis of said fire-retardant member and contacting said bottom surface of said fire-retardant member, said second intumescent member being substantially parallel to said at least one intumescent member.

16. The fire-retardant insert according to claim 14 wherein said fire-retardant member comprises mineral wool.

17. The fire-retardant insert according to claim 14 wherein said intumescent member contacts the top surface of said fire-retardant member.

18. The fire-retardant insert according to claim 15 further comprising a third intumescent member positioned within fire-retardant member and extending along at least a portion of the longitudinal axis of said fire-retardant member, said third intumescent member being substantially parallel to said at least one intumescent member.

19. The fire-retardant insert of according to claim 14 wherein said means for affixing comprises a flexible film circumscribing the top, bottom, and side surfaces of said fire-retardant member and all intumescent members.

20. A fire-retardant insert comprising:
an elongated fire-retardant member having a longitudinal axis and comprising a top surface, a bottom surface, end surfaces and side surfaces, the edges of each end surface and side surface contacting said top surface or said bottom surface, said top and bottom surfaces being substantially parallel and said side surfaces being non-parallel, so that said fire-retardant member is trapezoidal in cross-section;
a first intumescent member extending along at least a portion of the longitudinal axis of said fire-retardant member and contacting said top surface of said fire-retardant member;
a second intumescent member extending along at least a portion of the longitudinal axis of said fire-retardant member and contacting said bottom surface of said fire-retardant member; and
a flexible film circumscribing the top, bottom, and side surfaces of said fire-retardant member and said first and second intumescent members.
